(19) United States
(12) Patent Application Publication
(10) Pub. No.: US 2008/0170222 A1
(43) Pub. Date: Jul. 17, 2008

(54) METHODS AND SYSTEMS FOR DETERMINING VEHICLE WHEEL ALIGNMENT

(76) Inventors: Timothy A. Strege, Sunset Hills, MO (US); Nicholas J. Colarelli, St. Louis, MO (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/623,659

(22) Filed: Jan. 16, 2007

(51) Int. Cl. G01B 11/26

(52) U.S. Cl. 356/139.09

(57) ABSTRACT

Methods and systems for determining an alignment of the wheels of a vehicle are provided. The method includes determining values of wheel alignment parameters of a first wheel using images of a first optical target associated with the first wheel wherein the images are received by a first imager having a first field of view, and determining values of wheel alignment parameters of the first wheel using images of the first optical target received by a second imager having a second field of view when the first optical target is outside the first field of view.

### BACKGROUND OF THE INVENTION

This invention relates generally to vehicle wheel alignment and more particularly, to vehicle wheel alignment systems which measure the locations and orientations of the vehicle wheels.

At least some known machine vision vehicle wheel alignment systems such as shown in U.S. Pat. No. 6,298,284 B1 to Burns, Jr. et al. typically utilize a set of solid state imaging sensors mounted away from a vehicle undergoing an alignment inspection, to obtain images of wheel-mounted alignment targets. The alignment targets typically include patterns and/or known control features, as set forth in U.S. Pat. No. 6,064,750 to January et al. The positions of the features in the images are determined by a processing system using geometric relationships and mathematical algorithms, from which the position and orientation of the wheels or other vehicle components associated with each alignment target are identified.

Some machine vision vehicle wheel alignment systems, such as shown in U.S. Pat. No. 6,894,771 to Dorrance et al., do not use predefined alignment targets mounted to the vehicle wheels or components, but rather process images to identify either random or predetermined geometric features directly on the wheel, tire of a wheel assembly, or vehicle component, such as projected light stripes or geometric features. These systems typically use distortion or changes in the observed geometry to determine positions and orientations from which position and orientation measurements or wheel alignment data can be determined.

Vehicle service systems which utilize imaging sensors, such as vehicle wheel alignment systems, utilize imaging sensors which incorporate fixed lenses designed to view objects or features within a predetermined field of view. Imaging sensors utilizing fixed lenses generally compromise high image resolution and accuracy to accommodate the entire predetermined field of view, even though the objects or features which are of interest generally do not encompass the entire field of view. Rather, the objects or features, such as an alignment target mounted to a vehicle wheel assembly or the wheel assembly itself, typically only occupy a small portion of the sensor's field of view. However, since the specific location of the object or feature within the field of view can vary, the imaging sensor is required to have a field of view which is substantially larger than the object or feature, enabling the object or feature to be imaged at varied locations. Lifting a vehicle for example, in order to access the vehicle underside, changes the position of the target and/or wheel from a lower position in the field of view to a higher position in the field of view.

In vehicle wheel alignment systems, the goal of aligning vehicle wheels to within specific tolerances is important for optimal control of the vehicle and for consistent wear of the vehicle's tires. Alignment is performed primarily by adjusting for example, but not limited to, camber, caster, toe, and steering axis inclination. As part of calculating the alignment angles for the vehicle, the angles of the wheels must be determined. The angles can be determined relative to an external reference, such as found in machine-vision vehicle wheel alignment systems, or relative to the other wheels on the vehicle, such as found in wheel-mounted vehicle wheel alignment systems. In either case, the images formed on the detector arrays are analyzed such that accurate alignment angles can be calculated.

Machine-vision vehicle wheel alignment systems typically use solid state imaging sensors with fixed lenses mounted away from the vehicle to obtain images of wheel-mounted alignment targets. Each alignment target may incorporate an accurately reproduced pattern that has known control features, as set forth in U.S. Pat. No. 6,064,750. The position of the features in the image is found and an orientation of the wheel is calculated using mathematical algorithms. Some machine-vision systems do not use a predefined target but identify either random or predetermined geometric features directly on the wheel or tire of a wheel assembly, such as projected light stripes or the circular wheel rim, and use the distortion or changes in the geometry of the target or features to determine positions and orientations.

An imaging sensor needs a field of view which is sufficiently large enough to view alignment targets associated with the rear wheels of vehicles having different wheelbase lengths which range from a predetermined minimum to a predetermined maximum length and sufficiently large to be able to view the alignment targets at various elevations of the vehicle on a lift.

### BRIEF DESCRIPTION OF THE INVENTION

In one embodiment, a method for determining an alignment of the wheels of a vehicle includes determining values of wheel alignment parameters of a first wheel using images of a first optical target associated with the first wheel wherein the images are received by a first imager having a first field of view, and determining values of wheel alignment parameters of the first wheel using images of the first optical target received by a second imager having a second field of view when the first optical target is outside the first field of view.

In another embodiment, a wheel alignment apparatus for facilitating determining the alignment of the wheels of a vehicle includes a set of predetermined optical targets associated with first and second wheels of a vehicle The apparatus also includes at least a first imager positioned to receive images of ones of the optical targets associated with a first wheel of the vehicle, at least a second imager positioned to receive images of ones the optical targets associated with a second wheel of the vehicle, the second wheel being disposed on the same side of the vehicle as the first wheel, each of the imagers having a field of view, the first imager having its field of view directed at the optical target associated with the first wheel of the vehicle and the second imager having its field of view directed at the optical target associated with the second wheel of the vehicle. The apparatus further includes a processor communicatively coupled to the first and second imagers, the processor configured to determine values of wheel alignment parameters of the first wheel using images of the optical target associated with the first wheel received by the second imager.

In still another embodiment, a method of determining an alignment of the wheels of a vehicle includes determining values of wheel alignment parameters with the vehicle in a first position using a first optical target associated with a first wheel of the vehicle and a first imager aimed toward the first optical target wherein in the first position the first optical target is within a first field of view of the first imager and outside a second field of view of a second imager aimed at a second optical target associated with a second wheel of the vehicle. The method also includes positioning the vehicle in a second position wherein in the second position the first optical target is outside the first field of view and within the second field of view, and determining values of wheel alignment parameters with the vehicle in the second position using the first optical target and the second imager.

In still another embodiment, a wheel alignment apparatus for facilitating determining the alignment of the wheels of a vehicle includes a first optical target associated with a first wheel of the vehicle, the first optical target associated with at least a first imager having a first field of view directed toward the first optical target, a second optical target associated with a second wheel of the vehicle, the second wheel being disposed on the same side of the vehicle as the first wheel, the second optical target associated with at least a second imager having a second field of view directed toward the second optical target. The apparatus also includes a processor communicatively coupled to the first and second imagers wherein the processor is configured to determine values of wheel alignment parameters of the first wheel with the vehicle in a first position using images of the first optical target received by the first imager, and determine values of wheel alignment parameters of the first wheel with the vehicle in a second position using images of the first optical target received by the second imager.

### BRIEF DESCRIPTION OF THE DRAWINGS

FIG. 1 is a side schematic view of a vehicle wheel alignment system in accordance with an embodiment of the present invention;

FIGS. 2A and 2B are plan schematic views of vehicle wheel alignment system 100 in accordance with an embodiment of the present invention; and

FIG. 3 is a flow chart of an exemplary method of determining an alignment of the wheels of a vehicle using the vehicle wheel alignment system shown in FIG. 1.

### DETAILED DESCRIPTION OF THE INVENTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

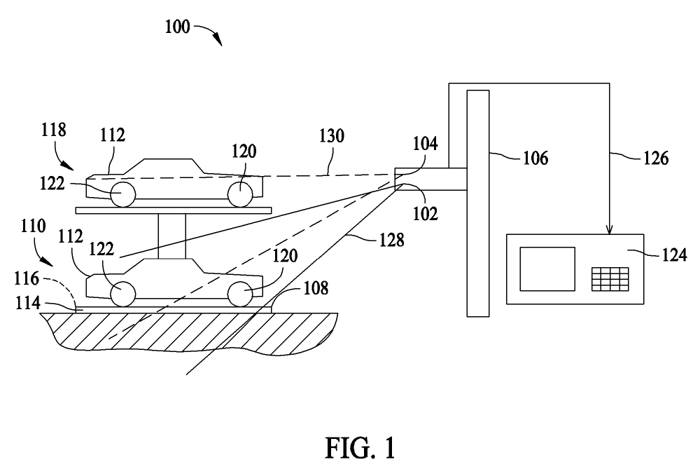

FIG. 1 is a side schematic view of a vehicle wheel alignment system 100 in accordance with an embodiment of the present invention. In the exemplary embodiment, alignment system 100 includes a first imaging sensor, or “imager” 102 and a second imager 104 mounted on a stanchion 106 positioned proximate a vehicle lift 108. In a first position 110 vehicle lift 108 is at or near ground level such that a vehicle 112 is capable of driving onto a plurality of runways 114, 116 of vehicle lift 108. Vehicle 112 is capable of being raised to a second position 118, where vehicle 112 may be easily serviced from below. In the exemplary embodiment, the vehicle suspension is serviceable for adjusting wheel alignment parameters.

In the exemplary embodiment, imagers 102, 104 are mounted adjacent with respect to each other and aimed at respective wheels on a single side of vehicle 112. For example, first imager 102 is aimed towards a first wheel 120 and second imager 104 is aimed towards a rear wheel 122. Each imager 102, 104 includes a field of view that is fixed and does not include a zoom, pan, or tilt capability. Such absence of capabilities permits imagers 102, 104 to be less costly and facilitates reducing the overall cost of system 100. In an alternative embodiment, imagers 102 and 104 include variable field of view lenses. In another alternative embodiment, imagers 102 and/or 104 include at least one of a pan, tilt, and zoom capabilities. Wheels 120 and 122 are configured to receive an optical target that is fixedly mounted to wheels 120 and 122 during an alignment procedure. Alternatively, wheels 120 and 122 do not include mounted optical targets but rather portions or features of wheels 120 and 122 are recognizable and used as optical targets for acquiring a position and an orientation of wheels 120 and 122. Images of wheels 120 and 122 received by imagers 102, 104 respectively are transmitted to a computer 124 through a communication link 126. Communication link 126 may be a wired, fiber optic, wireless, or other communication link capable of performing the functions described herein.

A first field of view 128 of imager 102 includes at least front wheel 120 when vehicle 112 is positioned on lift 108 in first position 110. A second field of view 130 of imager 104 includes at least rear wheel 122 when vehicle 112 is positioned on lift 108 in first position 110. Values of wheel alignment parameters may be determined with vehicle 112 in first position 110 using an optical target (not shown) coupled to the wheels or using a portion or feature of the wheels for reference. To adjust the suspension of vehicle 112 to bring the determined values of wheel alignment parameters into compliance with specifications for those values, vehicle 112 may be lifted to second position 118 using lift 108. As vehicle 112 is raised, front wheel 120 and rear wheel 122 change position within each respective imager field of view. As vehicle 112 is lifted higher, front wheel 120 moves out of front field of view 128 of front wheel imager 102. In accordance with an embodiment of the present invention, rear wheel imager 104 is used to image front wheel 120 when front wheel is outside front field of view 128 and within rear field of view 130.

In the exemplary embodiment, an alignment technician raises vehicle 112 high enough to adjust the suspension to correct values of wheel alignment parameters that are out of specification while still being able to monitor the values of wheel alignment parameters using rear imager 104 when front wheel 120 is outside front field of view 128. Viewing front wheel 120 using rear wheel imager 104 when front wheel 120 is outside of front field of view 128 permits expanding the effective front field of view 128 to include rear field of view 130 without costly additions of a lift for imagers 102 and 104, pan, tilt, or zoom units coupled to imagers 102 and/or 104 or adjustable field of view lenses for imagers 102 and 104. Embodiments of the present invention permits an extra approximately nine inches to approximately twelve inches of lift height of the vehicle during an alignment procedure than previously available using prior art alignment systems.

Although only imagers are described on one side of vehicle 112 it should be understood that a similar discussion holds for imagers mounted on the other side of vehicle 112 such that all four wheels are viewed by an associated imager.

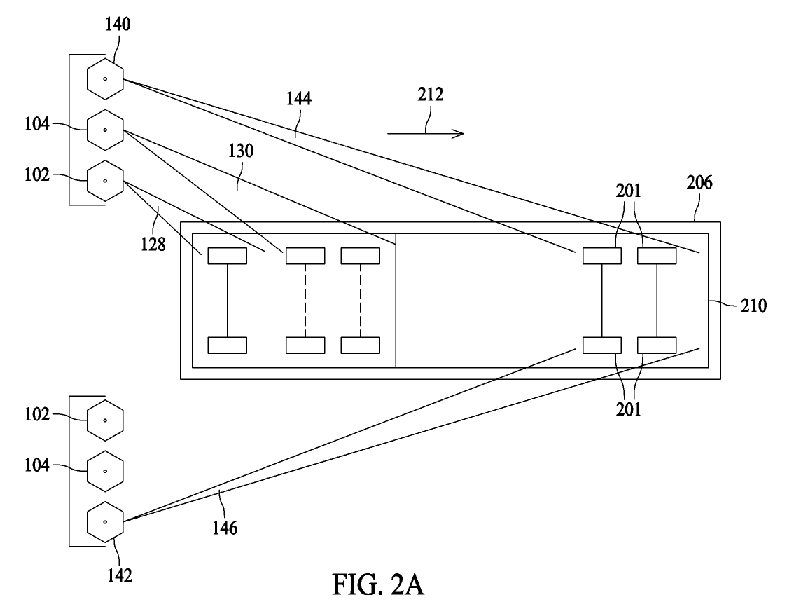

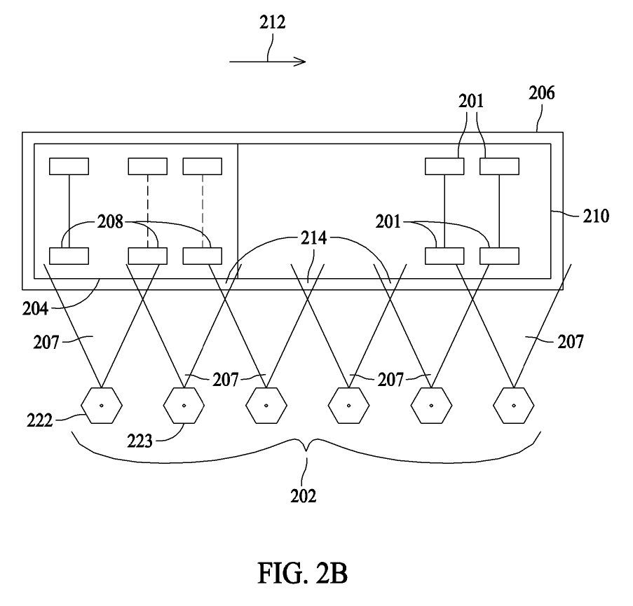

FIGS. 2A and 2B are plan schematic views of vehicle wheel alignment system 100 (shown in FIG. 1) in accordance with another embodiment of the present invention. In the alternative embodiment shown in FIG. 2A, one or more additional imagers 140, 142 may be included to permit viewing rear wheels 201 of extended length vehicles, for example, trucks. Each imager 140, 142 includes an associated field of view 144, 146 aimed at a predetermined or selectable position along vehicle lift 206 to accommodate various size vehicles. While this, and other embodiments, describe a vehicle lift 206, those skilled in the art will recognize that the area in which the vehicle rests could also be a floor in an inspection area or other suitable location for a vehicle.

Although only imagers are described on one side of vehicle 210 it should be understood that a similar discussion holds for imagers mounted on the other side of vehicle 210 such that all wheels are viewed by an associated imager.

FIG. 2B is a plan schematic view of vehicle wheel alignment system 100 in accordance with another embodiment of the present invention. In the exemplary embodiment, system 100 includes a first plurality of imagers 202 arranged along a first side 204 of a vehicle lift 206. Although only imagers are described on one side of vehicle lift 206 it should be understood that a similar discussion holds for additional imagers mounted on the opposite side of vehicle 206. Imagers 202 are aligned side by side horizontally such that a field of view 207 of each of imagers 202 overlaps a field of view of at least one adjacent other imager 202. The arrangement of imagers 202 permits continuous viewing of all wheels 201 and 208 of a vehicle 210 positioned on vehicle lift 206, including when vehicle 210 is rolled forward and/or backward on lift to determine a wheel runout compensation of respective wheels 201 and 208. Wheel run out compensation is typically performed by rolling the vehicle on vehicle lift 206 in a first direction 212, either forward or backward approximately eight to approximately twelve inches (approximately 200 mm to approximately 300 mm) and then optionally rolling vehicle 210 back to its approximate starting position. This rolling compensation permits accurate determination of the axis of rotation of wheels 208 even if the position of the targets and/or features of wheels 208 are imprecise. In the exemplary embodiment, vehicles of various wheelbases and numbers of wheels are accommodated using the plurality of imagers. For example, an automobile or other two axle vehicle is accommodated using at least two imagers and a cargo van type vehicle having three axles and tandem tractor trailer vehicles and other vehicle having multi-axles may be accommodated using up to six imagers.

During operation, a vehicle is positioned on vehicle lift 206 such that wheels 201 and 208 are each in a field of view of at least one of the plurality of imagers 202. The vehicle is rolled in direction 212 while viewing wheels 201 and 208 using imagers 202. Each of wheels 201 and 208 may remain in the field of view of a first imager 222 or may enter an overlap area 214 where wheel 208 is positioned in a field of view of the first imager 222 and in the field of view of a second adjacent of the plurality of imagers 202. In addition, wheels 201 and 208 may also leave the field of view of first imager 222 and remain in the field of view of second imager 223. Accordingly, wheels 201 and 208 may be tracked from the field of view of a first imager 222 to a field of view of a second imager 223 during a wheel runout compensation procedure.

It is understood that one or more the foregoing wheel alignment imaging features may utilized simultaneously to view vehicle wheels in a field of view of an imager coupled to the alignment system. That is, wheel imaging during wheel alignment may be achieved with combinations of imagers located about the vehicle such that the wheels enter or remain in a field of view of a second imager even when moved outside the field of view of a first imager.

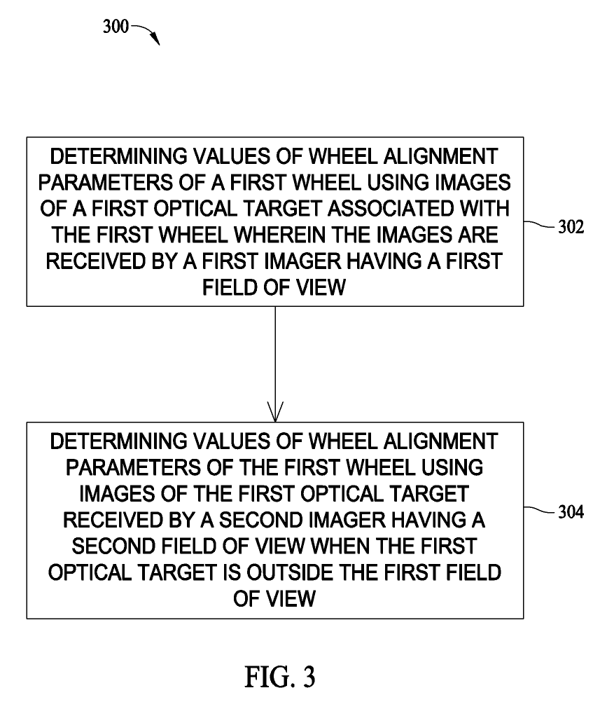

FIG. 3 is a flow chart of an exemplary method 300 of determining an alignment of the wheels of a vehicle using vehicle wheel alignment system 100 (shown in FIG. 1). Typically, each imager is dedicated to viewing a respective optical target or wheel assembly feature associated with the front wheel or the rear wheel of the vehicle. The focal length of the imager aimed at the front wheel is different than the focal length of the imager aimed at the rear wheel, therefore the image of the front wheel in the imager aimed at the rear wheel may be of less than optimal quality due to being slightly out of focus. Because of the differences in focal length of the lenses of the imagers, viewing the front wheel in the imager designed to view the rear wheel is not generally considered to be a reasonable option compared to extending the field of view of the front imager. In exemplary method 300, vehicle 112 can be moved to a position wherein the front wheel exits the field of view of the front wheel imager. To extend the apparent field of view of the front wheel imager, the rear wheel imager is used to determine values of wheel alignment parameters of the front wheel when the front wheel is outside the field of view of the front imager. Method 300 includes determining 302 values of wheel alignment parameters of a front wheel using images of a first optical target associated with the front wheel. In one embodiment the first optical target comprises a target manually coupled to the front wheel that facilitates determining the wheel alignment parameters. In an alternative embodiment, the first optical target comprises features of the front wheel itself that are used to facilitate determining the wheel alignment parameters. The images are received by a first imager aimed at the front wheel having a first field of view. Method 300 also includes determining 304 values of wheel alignment parameters of the front wheel using images of the front optical target received by a rear wheel imager having a second field of view when the front wheel optical target is outside the front imager field of view.

Although method 300 is described above in a specific context of front and rear wheels, and corresponding field of views, those skilled in the art will recognize that method 300, as shown in FIG. 3, is not limited to the exemplary embodiment described above.

The above-described methods and systems for aligning vehicle wheels using a machine vision alignment system are cost-effective and highly reliable. The methods include viewing front and rear wheel targets using an associated imager to determine values of wheel alignment parameters and when one of the targets is outside the field of view of the associated imager, using the imager associated with the other target for determining values of wheel alignment parameters. The methods facilitate expanding the effective field of view of an imager by transferring its function to another imager when the target is outside the field of view of the imager.

While the invention has been described in terms of various specific embodiments, those skilled in the art will recognize that the invention can be practiced with modification within the spirit and scope of the claims.

What is claimed is:

1. A method of determining an alignment of the wheels of a vehicle, said method comprising:
determining values of wheel alignment parameters of a first wheel using images of a first optical target associated with the first wheel, said images received by a first imager having a first field of view; and
determining values of wheel alignment parameters of the first wheel using images of the first optical target received by a second imager having a second field of view when the first optical target is outside the first field of view.

2. A method in accordance with claim 1 further comprising determining values of wheel alignment parameters of a second wheel using images of a second optical target associated with the second wheel received by the second imager.

3. A method in accordance with claim 1 further comprising elevating the vehicle from a first position to a second position wherein in the first position the first optical target is within the first field of view and outside the second field of view.

4. A method in accordance with claim 3 wherein in the second position the first optical target is outside the first field of view and within the second field of view.

5. A method in accordance with claim 1 further comprising determining a wheel run-out compensation of at least one wheel using a plurality of imagers having overlapping fields of view

6. A method in accordance with claim 5 further comprising determining a wheel run-out compensation of at least one wheel using a plurality of imagers wherein the imagers are spaced horizontally along a side of the vehicle.

7. A method of facilitating alignment of the wheels of a vehicle, said method comprising:
receiving images of a first optical target associated with a first wheel of the vehicle using at least a first imager having a first field of view; and
determining values of wheel alignment parameters of the first wheel using images of said first optical target received by a second imager having a second field of view when said first optical target is outside the first field of view.

8. A method in accordance with claim 7 further comprising receiving images of a second optical target associated with a second wheel of the vehicle using at least the second imager.

9. A method in accordance with claim 7 further comprising determining values of wheel alignment parameters of the first wheel using images of said first optical target received by the first imager when said first optical target is within the first field of view.

10. A method in accordance with claim 7 further comprising determining a wheel run-out compensation of at least one of the first and second wheel using images of a respective optical target associated with the at least one of first and second wheel wherein said images are received from a first imager when the optical target is in the first field of view and from a second imager when the optical target is in the second field of view.

11. A method in accordance with claim 10 wherein said images are received from at least one of the first imager and the second imager when the optical target is in an overlap of the first and the second fields of view.

12. A wheel alignment apparatus for facilitating determining the alignment of the wheels of a vehicle, said apparatus comprising:
a set of optical targets associated with first and second wheels of a vehicle, wherein said set of optical targets comprises at least one of a target mounted on a respective wheel and a feature of at least one of a respective wheel and tire;
at least a first imager positioned to receive images of ones of said optical targets associated with a first wheel of the vehicle;
at least a second imager positioned to receive images of ones said optical targets associated with a second wheel of the vehicle, said second wheel being disposed on the same side of the vehicle as said first wheel, each of said imagers having a field of view, the first imager having its field of view directed at the optical target associated with said first wheel of the vehicle and the second imager having its field of view directed at the optical target associated with said second wheel of the vehicle; and
a processor communicatively coupled to said first and second imagers, said processor configured to determine values of wheel alignment parameters of the first wheel using images of said optical target associated with the first wheel received by the second imager.

13. A wheel alignment apparatus in accordance with claim 12 wherein said processor is further configured to determine values of wheel alignment parameters of the first wheel using the second imager when the first wheel is positioned outside the field of view of the first imager.

14. A method of determining an alignment of the wheels of a vehicle, said method comprising:
determining values of wheel alignment parameters with the vehicle in a first position using a first optical target associated with a first wheel of the vehicle and a first imager aimed toward the first optical target wherein in the first position the first optical target is within a first field of view of the first imager and outside a second field of view of a second imager aimed at a second optical target associated with a second wheel of the vehicle;
positioning the vehicle in a second position wherein in the second position the first optical target is outside the first field of view and within the second field of view; and
determining values of wheel alignment parameters with the vehicle in the second position using the first optical target and the second imager.

15. A method in accordance with claim 14 wherein said first optical target comprises at least a portion of the first wheel.

16. A method in accordance with claim 14 wherein said second optical target comprises at least a portion of the second wheel.

17. A method in accordance with claim 14 further comprising determining values of wheel alignment parameters of the first wheel using the second imager when the first wheel is positioned outside the field of view of the first imager.

18. A wheel alignment apparatus for facilitating determining the alignment of the wheels of a vehicle, said apparatus comprising:
a first optical target associated with a first wheel of the vehicle, said first optical target associated with at least a first imager having a first field of view directed toward said first optical target;
a second optical target associated with a second wheel of the vehicle, the second wheel being disposed on the same side of the vehicle as the first wheel, said second optical target associated with at least a second imager having a second field of view directed toward the second optical target; and
a processor communicatively coupled to said first and second imagers, said processor configured to:
determine values of wheel alignment parameters of the first wheel with the vehicle in a first position using images of said first optical target received by the first imager; and
determine values of wheel alignment parameters of the first wheel with the vehicle in a second position using images of said first optical target received by the second imager.

19. An apparatus in accordance with claim 18 wherein the second position is elevated with respect to the first position.

20. An apparatus in accordance with claim 18 wherein in the second position said first optical target is outside the first field of view.
